(19) United States
(12) Patent Application Publication
(10) Pub. No.: US 2013/0124416 A1
(43) Pub. Date: May 16, 2013

(54) METHOD AND SYSTEM FOR TRANSFERRING FUNDS OVER A VOICE CALL

(71) Applicants: SHARAD PAWAR, Bangalore (IN); SAMPATH RAMACHANDRAN, Bangalore (IN); MANJUNATH GUNDURAO, Bangalore (IN); SANJAY HERLE, Bangalore (IN); TEJASVI GANGAIAH, Bangalore (IN)

(72) Inventors: SHARAD PAWAR, Bangalore (IN); SAMPATH RAMACHANDRAN, Bangalore (IN); MANJUNATH GUNDURAO, Bangalore (IN); SANJAY HERLE, Bangalore (IN); TEJASVI GANGAIAH, Bangalore (IN)

(73) Assignee: BEWO TECHNOLOGIES PVT. LTD, Bangalore (IN)

(21) Appl. No.: 13/673,885

(22) Filed: Nov. 9, 2012

(30) Foreign Application Priority Data
Nov. 11, 2011 (IN) 3880/CHE/2011

(51) Int. Cl. G06Q 20/10; G06Q 20/40

(52) U.S. Cl. 705/44

(57) ABSTRACT

The various embodiments herein provide a method and system for transferring funds between users over a voice call. The method comprises registering a plurality of users for funds transfer with a payment system, initiating the voice call between a payer and a payee involved in the funds transfer, establishing a communication link with the payment system during the voice call, providing a funds transfer request to the payment system by the payer, prompting an authentication token and providing a biometric signature of the payer and the payee to the payment system, verifying identity of the payer and the payee based on the authenticity of the biometric signature, retrieving the payer and the payee details from a central database, initiating the funds transfer and sending a funds transfer notification to the payer and the payee indicating that the payment from the payer to the payee has been made.

### CROSS-REFERENCE TO RELATED APPLICATIONS

The present application claims priority of Indian provisional application serial number 3880/CHE/2011 filed on Nov. 11, 2011, and that application is incorporated in its entirety at least by reference.

### BACKGROUND

1. Technical Field

The embodiments generally relate to secure funds transfer and particularly relates to a peer-to-peer funds transfer over a voice call. The embodiments more particularly relates to methods and systems for authenticating secure funds transfer using biometric data.

2. Description of the Related Art

Conventional fund transfer methods include paper based payment systems such as writing checks, Electronic funds transfer (EFT) such as pre-authorized payment, internet banking, mobile banking etc. However, the paper based payment system is archaic, slow, time consuming and results in delayed receipt of funds due to transit time of the postal service and additional cost of mailing, postage etc. Challenges with EFT includes requirement of computer devices, internet connection for users, credit cards and the users need to provide the bank details, information of the transfer details and the beneficiary details.

Currently, mobile payment service industry is the one of the fastest growing niches in the world of financial transaction which allows users to conveniently and securely complete a two-way transaction making it possible to send funds immediately to anyone, anywhere over a registered mobile phone number. However, the existing mobile banking applications face severe security threats. The current mobile banking applications require the consumers to register or activate the application with the bank/MNO/vendor offering the service in the market. Since the consumer data is typically stored in the application, or entered by the consumer and encrypted by the application in the SIM or handset, the consumer data is not secured. The application can be tampered to get financial data. Also, the conventional mobile banking operations are conducted through an Internet connection.

The current funds transfer systems enables only the users having portable smart devices to initiate the fund transfers and to perform run-time identification. In rural areas where there is only limited access to technology or resources, it is difficult to initiate fund transfer and to properly identify the authenticity of individuals making/receiving the transaction.

Also the conventional funds transfer system involve only the use of a unique password or identification number for authenticating the users while making a funds transfer. However, in many cases, reliable and efficient identification of sender/recipient is particularly problematic for monetary fund transfers as any person can prompt the transaction ID to initiate the funds transfer. Also in many cases, financial transactions are linked with the users registered devices for verifying the user identity, send the transfer notifications, provide the one time password and the like, thereby making the transaction device dependent.

In view of the foregoing, there is a need for a method and system for providing secure transfer of funds between users over a voice call. Further there is a need for a method and system for instantaneous transfer of funds without the need for providing any transaction details for authentication. Further, there is a need for a method and system for enabling transfer of funds between users without the need of internet connectivity.

The above mentioned shortcomings, disadvantages and problems are addressed herein and which will be understood by reading and studying the following specification.

### SUMMARY

The primary object of the embodiments herein is to provide a method and system for transferring funds from a payer to a payee over a voice call.

Another object of the embodiments herein is to provide a method and system for transferring funds from a payer to a payee without the need for internee connectivity.

Another object of the embodiments herein is to provide a method and system for transferring funds over a voice call which is device independent.

Another object of the embodiments herein is to provide a method and system for transferring funds which authenticates the identity of the payer/payee over a biometric signature.

Another object of the embodiments herein is to provide a method and system for transferring funds by providing a communication protocol for authentication of the payer/payee during the voice call.

Another object of the embodiments herein is to provide a method and system for transferring funds which enables the user to directly start with biometric authentication without providing any user data.

Yet another object of the embodiments herein is to provide a method and system for transferring funds from a payer to payee which avoids security problems of the internet.

Yet another object of the embodiments herein is to provide a convenient, flexible and instantaneous method and system for transferring funds from a payer to the payee.

Yet another object of the embodiments herein is to provide a method and system for providing instantaneous transaction information and other information as desired on transfer of funds from a payer to a payee.

Yet another object of the embodiments herein is to provide a method and system for transferring funds without requiring either a payer or a payee to remember or store other party's account details.

Yet another object of the embodiments herein is to provide a method and system for transferring funds from a payer to a payee without exposing the sensitive information to one another.

Yet another object of the embodiments herein is to provide a telephone-based method and system for transferring funds which enables a user to perform the funds transfer safely and securely and in a convenient fashion.

The various embodiments herein provide a method and system for transferring funds from a payer to a payee over a voice call. The embodiments herein enable at least two users on a voice call to pay each other through an intermediate payment system. The process starts with the payer making a voice call to the payee. If the payer wants to transfer the funds to the payee in real time while on a voice call with the payee, the payer dials a support number which brings the payment system into conference call with the transacting parties. The payment system retrieves the information of the payer using a biometric signature associated with the payer. On authentication of the payer, the payment system asks the payer to provide the amount to be transferred to the payee. The payment system then gets transferred to the payee providing them with an authentication interface. The payee provides the associated authentication signature, on authentication of the biometric signature from the payee, the money gets transferred to the payee. The payer's account gets debited with the amount and the payment system sends a funds transfer notification to the payee. Further the payee's account gets credited with the amount and the payment system sends a funds transfer notification to the payee.

According to an embodiment herein, the method comprises receiving a registration request from one or more users, recording a plurality of user details of each user in the payment system, providing each user with an authentication token on confirmation of a successful registration by the payment system, where the authentication token one of an unique ID and a password, initiating the voice call between at least two users, where the at least two users comprise a payer and a payee involved in a funds transfer, establishing a communication link with the payment system during the voice call, providing a funds transfer request to the payment system by the payee, prompting the authentication token by the payer and the payee, providing a biometric signature of the payer and the payee to the payment system, authenticating the biometric signature of the payer and the payee, retrieving the payer and payee details from a central database, initiating the funds transfer and sending a funds transfer notification to the payer and the payee indicating that the payment from the payer to the payee has been made.

According to an embodiment herein, the biometric signature comprises at least one of a finger print, a hand print, a voice print, an iris pattern, a facial feature and a handwriting sample.

According to an embodiment herein, the user device is at least one of a telephone, a mobile phone, PDA, a laptop, or any smart device.

According to an embodiment herein, the communication link is a voice call.

According to an embodiment herein, the authentication of the users is performed by matching the biometric signature of the users with a registered biometric data.

According to an embodiment herein, a DTMF signaling is employed for communicating the biometric signature with the payment system and authenticating the users during the voice call. According to an embodiment herein, the method of authenticating the users for funds transfer comprises launching an authentication interface in a user device, establishing the voice call with the payment system, providing a DTMF request associated with an user to authenticate the user with the payment system, verifying the authenticity of the user by the payment system, sending a DTMF response to the user device and validating the users with authenticated/unauthenticated DTMF codes based on the DTMF response.

According to an embodiment herein, the biometric signature is inputted to an authentication interface of the payment system through at least one of a keypad, touchpad, a voice recognition device or any biometric device.

According to an embodiment herein, the DTMF code is sent as the DTMF request to the payment system to determine the authenticity of the user and the DTMF response is one of a DTMF code in case of successful authentication or an error code in case of unsuccessful authentication.

According to an embodiment herein, the payment system verifies the authenticity of the users by performing text dependent, text prompted and text independent phrase verification and initiates the funds transfer between the payer and the payee through EFT.

According to an embodiment herein, the funds transfer notification is sent to the users through at least one of an SMS, a voice message and an email.

Embodiments herein further disclose a system for transferring funds over a voice call. The system comprises a payment system for initiating a funds transfer between a payer and payee in communication with each other. The payment system comprises an application server and a central database. The application server comprises a registration module for registering a plurality of users for funds transfer and an authentication module for authenticating the plurality of users. The central database is adapted for storing credentials and a biometric data associated with the plurality of users and an authentication token generated for the payer for verification during the fund transfer process.

According to an embodiment herein, the payment system implements an EFT for transferring funds from payer's account to payee's account.

According to an embodiment herein, the system farther comprises an application interface to provide biometric signature to the payment system for authentication.

According to an embodiment herein, the application server is adapted for backend biometric data processing.

According to an embodiment herein, the payment system employs a two way DTMF signaling for communicating biometric information over the voice call.

According to another embodiment herein, the system and methods employs the payment system as a conventional check out system for transferring funds alone or in conjunction with the purchase of goods and/or services.

According to an embodiment herein, the funds transfer herein refers to a person-to-person payment transaction or a person-to-merchant payment transaction.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating a system for transferring funds from a payer to a payee over a voice call, according to an embodiment of the present disclosure.

FIG. 2 is a flow chart illustrating a method for transferring funds from a payer to a payee over a voice call, according to an embodiment of the present disclosure.

FIG. 3 is a flow diagram illustrating a method of transferring funds from a payer to a payee by conferencing a payment system according to an embodiment of the present disclosure.

FIG. 4 is a flow diagram illustrating a process for bridging payment system with a plurality of enterprise applications, according to an embodiment of the present disclosure.

Although the specific features of the present disclosure are shown in some drawings and not in others. This is done for convenience only as each feature may be combined with any or all of the other features in accordance with the present disclosure.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The primary object of the embodiments herein is to provide a method and system for transferring funds over a voice call. The method comprises a payment system receiving a request for registration from a plurality of users, recording a plurality of user details of each user in the payment system, providing each user with an authentication token on confirmation of a successful registration by the payment system; where the authentication token is a unique ID or a password. The method further comprising initiating the voice call between at least two users, where the at least two users comprise a payer and a payee involved, in a thuds transfer, establishing a communication link with the payment system during the voice call, providing a funds transfer request to the payment system by the payer, prompting the authentication token by the payer and the payee, providing a biometric signature of the payer and the payee to the payment system, authenticating the biometric signature of the payer and the payee, retrieving the payer and payee details from a central database, initiating the funds transfer and sending a funds transfer notification to the payer and the payee indicating that the payment from the payer to the payee has been made. Here the payer and the payee are registered users of the payment system.

The biometric signature comprises at least one of finger prints, hand prints, voice prints, retinal/iris patterns, facial features and handwriting samples of the payer and the payee. The user device is at least one of a telephone, a mobile phone, PDA, a laptop, or any smart device associated with the payer and the payee.

The embodiments herein use a two way DTMF signaling for communicating the biometric signature with the payment system and authenticating the users during the voice call, where the DTMF signaling employs DTMF codes for communicating the biometric signature. The method of authenticating the users for funds transfer comprises launching an authentication interface in a user device, establishing a voice call with the payment system, providing a DTMF request associated with an user to authenticate the user with the payment system, verifying the authenticity of the user by the payment system, sending a DTMF response to the user device and validating the users with authenticated/unauthenticated codes based on the DTMF response. The DTMF response is one of a DTMF code in case of successful authentication or an error code in case of unsuccessful authentication.

The biometric signature is inputted to the authentication interface of the payment system through at least one of a keypad, touchpad, a voice recognition device or any biometric device.

The authentication of the users is performed by matching the biometric signature of the users with a registered biometric data. The payment system verifies the authenticity of the users by performing text dependent, text prompted and text independent phrase verification and initiates the funds transfer between the payer and payee through EFT.

The funds transfer notification is sent to the users through at least one of an SMS, a voice message and an email.

Embodiments herein further disclose a system for transferring funds over a voice call. The system comprises a payment system for initiating a funds transfer between a payer and payee in communication with each other. The payment system comprises an application server and a central database. The application server comprises a registration module for registering a plurality users for funds transfer and an authentication module for authenticating the plurality of users. The central database is adapted for storing credentials and biometric data associated with the plurality of users and an authentication token generated for the payer for verification during the fund transfer process.

According to an embodiment herein, the payment system in some case debits the amount from the payers account to the account of the payment system and credits the amount to the payee's account through EFT.

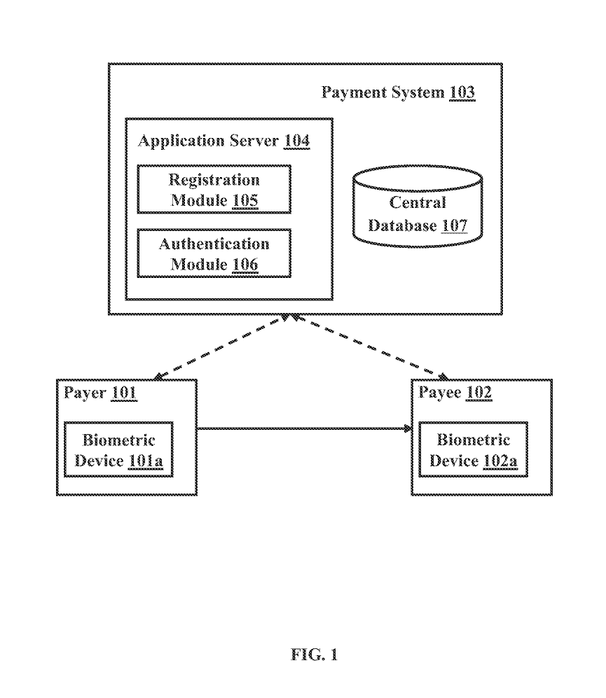

FIG. 1 is a block diagram illustrating a system for transferring fund from a payer to a payee using a mobile device, according to an embodiment of the present disclosure. The system includes a communication device associated with a payer 101, a payment system 103 and communication device of a payee 102.

The communication device of the payer 101 comprises a biometric device 101a and the communication device of the payee 102 comprises a biometric device 102a associated with them. The payer 101 and the payee 102 are the registered users of the payment system 103. The payment system 103 comprises an application server 104 and a central database 107. The application server 104 comprises a registration module 105 for registering a plurality of users with the payment system 103 and an authentication module 106 for authenticating the payer 101 and the payee 102 during a funds transfer. The central database 107 stores the user credentials provided during the registration. The central database 107 further stores biometric data of the registered users for performing biometric authentication during fund transfer process. The central database 107 also stores a unique pin dynamically generated by the payment system 103 for authentication process. The payment system 103 implements EFT for transferring fund from payer's account to payee's account.

The system enables the payer 101 and the payee 102 on a voice call to pay each other through the intermediate payment system 103. The process starts with the payer making a voice call to the payee 102 using a payer's communication device. If the payer 101 needs to transfer the funds to the payee 102 at real time while on a voice call with the payee 102, the payer 101 calls a support number which brings the payment system 103 into conference call with the transacting parties. The application server 104 retrieves the information of the payer 102 from the central database 107 and provides the payer 102 with an application interface wherein the payer provides their biometric signature. The authentication module 106 then compares the biometric signature with the biometric data recorded during registration to verify the identity of the payer/payee.

On authentication of the payer 101, the payment system 103 asks the payer 101 to provide the amount to be transferred to the payee 102. The payment system 103 then gets transferred to the payee 102 providing them with an authentication interface. On successful authentication of the biometric signature of the payee 102, the payment system 103 transfers the money to the payees account. The payment system 103 debits the amount from the payers account and sends a notification to the payer's communication device. Simultaneously, the payment system 103 sends a notification to the payee's communication device once the payee's account is credited with the amount.

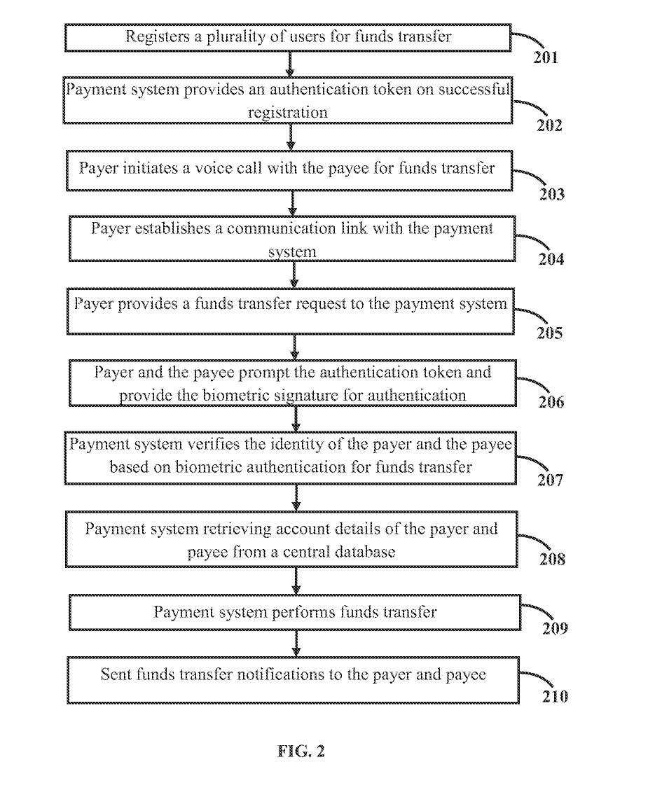

FIG. 2 is a flow chart illustrating a method for transferring from a payer to a payee using a mobile device according to an embodiment of the present disclosure. The payer and the payee register with the payment system by providing a plurality of authentication credentials at 201. The payment system provides an authentication token to the payer and the payee on successful completion of the registration at 202. The payer initiates a fund transfer with a payee through a communication device during a voice call between the payer and payee at 203. The payer establishes a communication link with the payment system 204 and conferences the payment system by dialing a support number and provides a funds transfer request to the payment system at 205. At 206, the payment system demands the payer to prompt the authentication token and the biometric signature to authenticate the user and to approve the payment process. On successful verification of the identity of the payer and the payee based on the biometric authentication 207, the payment system retrieves the account details of both the payer and the payee from a central database at 208. Further the payment system, initiates the fund transfer to the payees account through EFT at 209. The payment system then sends a notification to the payer and the payee on successful completion of the fund transfer at 210.

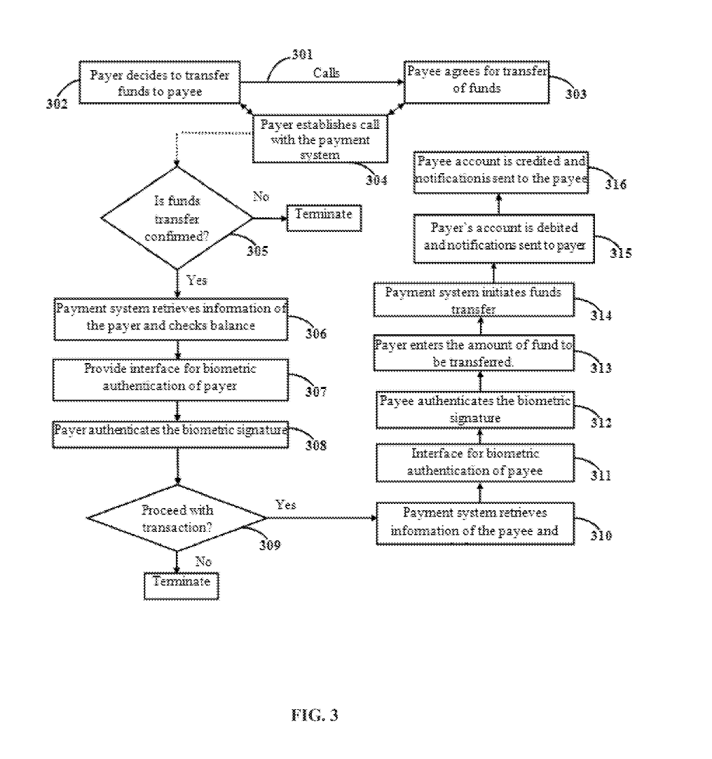

FIG. 3 is a flow diagram illustrating a method of transferring funds from a payer to a payee by conferencing a payment system according to an embodiment of the present disclosure. The funds transfer process starts with the payer making a voice call to the payee indicated by the arrow 301. The payer decides to transfer fund to the payee at 302 and the payee agrees for the transaction at 303. For the payer to transfer fund to the payee on a voice call, the payer dials a support number and establishes a conference call with the payment system at 304. The payment system confirms with the payer whether to proceed with the fund transfer at 305. If yes, the payment system retrieves the information of the payer and checks the balance in the account at 306, if the payer account has sufficient balance, the payment system provides the payer with an authentication interface at 307. The payer authenticates with the payment system through the pre-registered biometric signature at 308 and proceeds with transaction on successful authentication at 309. The payment system retrieves the information of the payee at 310. The payment system further provides the payee with the authentication interface at 311. On authentication of the biometric signature of the payee at 312, the payment system switches back to the payer and asks the payer to provide the amount to be transferred to the payee at 313. Once the payer provides the amount to be transferred, the payment system initiates the fund transfer and the money gets transferred to the payees account at 314. The amount gets debited from the payers account and the payment system sends a corresponding notification to the payer at 315. Similarly the payment system sends a notification to the payee once the amount is credited to the payee account at 316.

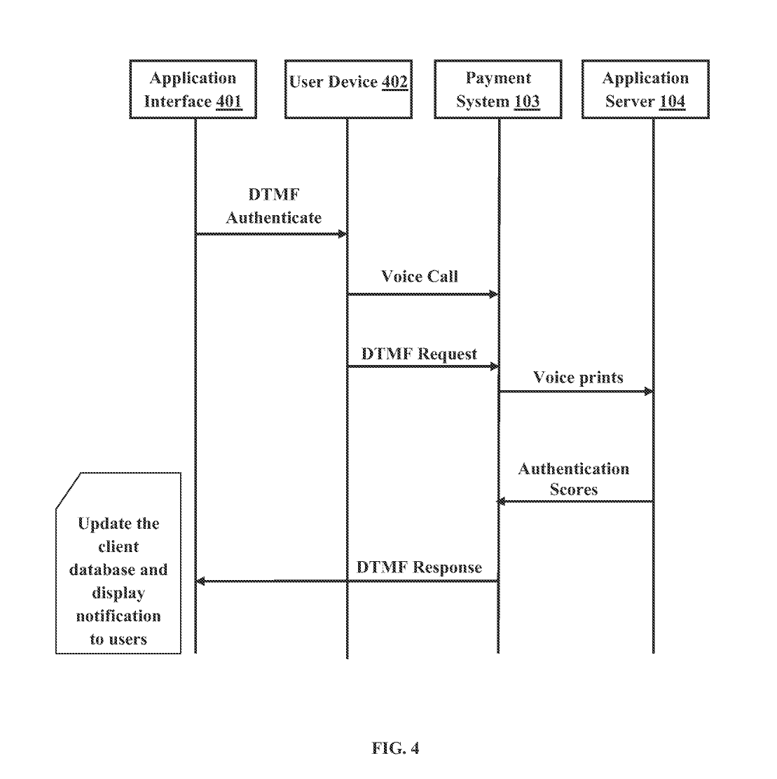

FIG. 4 is a flow diagram illustrating a process for bridging payment system for funds transfer, according to an embodiment of the present disclosure. According to FIG. 4, the application interface 401 provides a DTMF code for each user to authenticate for the biometric signature. The user device 402 establishes a call with the payment system 103 and sends biometric prompts of the user to the payment system 103. The user device 402 sends the DTMF code as a DTMF request to the payment system 103. The payment system 103 executes the voice prints and forwards the biometric tags of the user to the application server 104 at the backend. The application server 104 processes the DTMF codes and biometric tags and sends the authentication score back to the payment system 103. Further the payment system 103 sends the score as DTMF response including the identification of the user to the user device. In case of successful authentication, the DTMF response is DTMF code associated with the biometric signature of the user. In case of unsuccessful authentication, the DTMF response is an error code. The enterprise application marks the user with the authenticated/unauthenticated user. Further the enterprise application informs the authentication status as authenticated/unauthenticated to the user and updates the database 106 in the application server 104. On the basis of authentication of the user, the enterprise application provides one or more services to the users.

The payment system herein uses biometrics for authenticating the payer and the payee. For authentication using biometrics, the payment system compares the biometric signature provided by the payer against the biometric data associated with the user previously stored in the database of the application server. Similarly, the payment system authenticates the payee using biometrics by comparing the biometric signature sent by the payee with the biometric data stored in the database of the application server.

In another embodiment herein, the payer and payee is authenticated by dynamically generating an authentication token such as a unique ID or a password by the authentication module and sends the authentication token to the payer and the payee communication device. The user then confirms the authentication token to authenticate with the payment system.

The embodiments herein provides for DTMF and biometric authentication for muster roll. The applications on the user devices dial into the payment system for biometric authentication. After the call gets established, the DTMF gets exchanged between the user and application server for user identification and follows the biometric authentication. After successful authentication, DTMF codes along with scores are sent as a response to the application which then announce the user authenticity and update the database with results.

The embodiments herein enable the users to perform a secure funds transfer over a voice call using biometrics data for authentication.

The method and system for transferring funds according to the present disclosure does not require any internet connectivity and also does not expose the sensitive information such as the payer and payee details to others. Also the payer or the payee need not have to remember or store other party's account details.

The embodiments herein do not require the involvement of any data enabled platform for initiating the fund transfer. Also the user verification process is device independent which enables the system to perform correct identification of the intended user.

The embodiments herein further provide an instantaneous transaction information message based on which the users can decide whether the fund transfer is successfully completed or not. The information message can be either an audio/text message. In case of audio message, the user can listen to the audio output to understand the status of the transaction and does not have to view the textual information on the user device.

The fund transfer method and system herein is efficient, convenient, flexible and less time consuming.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A method of transferring funds over a voice call comprises:
registering a plurality of users with a payment system for a funds transfer;
initiating the voice call between at least two users; where the at least two users comprise a payer and a payee involved in the funds transfer;
establishing a communication link with the payment system during the voice call;
providing a funds transfer request to the payment system by the payer;
prompting an authentication token by the payer and the payee to the payment system; where the authentication token is one of a unique ID or password;
providing a biometric signature of the payer and the payee to the payment system,
verifying identity of the payer and the payee based on the authenticity of the biometric signature;
retrieving the payer and the payee details from a central database;
initiating the funds transfer in response to an authentication of the biometric signature; and
sending a funds transfer notification to the payer and the payee indicating that the payment from the payer to the payee has been made.

2. The method of claim 1, wherein registering the plurality of users for the funds transfer comprises:
receiving a registration request from a plurality of users;
collecting a plurality of user credentials associated with each user;
recording a biometric signature of each user; and
providing the authentication token to each user on confirmation of a successful registration with the payment system;
wherein the plurality of user credentials comprise name, account details and payment institutions.

3. The method of claim 1, wherein the biometric signature comprises at least one of a finger print, a hand print, a voice print, an iris patterns, a facial feature and handwriting sample.

4. The method of claim 1, wherein authentication of the users is performed by matching the biometric signature of the users with a registered biometric data.

5. The method of claim 1, further comprising employing a two-way DTMF signaling for communicating the biometric signature with the payment system.

6. The method of claim 5, wherein the DTMF signaling employs DTMF codes for authenticating the users during voice call.

7. The method of claim 5, wherein authenticating the users for funds transfer comprises:
launching an authentication interface in a user device;
establishing the voice call with the payment system;
providing a DTMF request associated with an user to authenticate the user with the payment system;
verifying the authenticity of the user by the payment system;
sending a DTMF response to the user device; and
validating the users with DTMF codes based on the DTMF response.

8. The method of claim 5, wherein the biometric signature is inputted to an authentication interface of the payment system through at least one of a keypad, touchpad, voice recognition device or any biometric device.

9. The method of claim 5, wherein the DTMF response is one of a DTMF code in case of successful authentication or an error code in case of unsuccessful authentication.

10. The method of claim 1, wherein the payment system verifies the authenticity of the users by performing text dependent, text prompted and text independent phrase verification.

11. The method of claim 1, wherein the payment system initiates the funds transfer between the payer and the payee through Electronic Funds Transfer (EFT).

12. The method of claim 1, wherein the funds transfer notification is sent to the users through at least one of a Short Message Service (SMS), a voice message and an email.

13. A system for transferring funds over a voice call comprises:
a payment system for initiating a funds transfer between a payer device and payee device in communication with each other, wherein the payment system comprises;
an application server comprising:
a registration module for registering a plurality of users for funds transfer; and
an authentication module for authenticating the plurality of users; and
a central database for storing credentials and a biometric data associated with the plurality of users.

14. The system of claim wherein the database further stores an authentication token generated for the user for verification during the fund transfer process.

15. The system of claim 12, wherein the payment system implements an EFT for transferring funds from payer's account to payee's account.

16. The system of claim 12, wherein the payer/payee device is at least one of a telephone, a mobile phone, PDA, a laptop, or any smart device.

17. The system of claim 12, further comprises an application interface to provide biometric signature to the payment system for authentication.

18. The system of claim 12, wherein the payment system employs a two way DTMF signaling for communicating biometric information over the voice call.
